(19) United States
(12) Patent Application Publication
(10) Pub. No.: US 2006/0084049 A1
(43) Pub. Date: Apr. 20, 2006

(54) Method and apparatus for online assignment and/or tests

(76) Inventor: Gabriel J. Lucas, San Francisco, CA (US)

Correspondence Address: SCHNECK & SCHNECK, P.O. BOX 2-E, SAN JOSE, CA, 95109-0005, US

(21) Appl. No.: 11/252,496

(22) Filed: Oct. 18, 2005

Related U.S. Application Data
(60) Provisional application No. 60/620,087, filed on Oct. 18, 2004.

(51) Int. Cl. G09B 7/00

(52) U.S. Cl. 434/323

(57) ABSTRACT

A method and computer-readable storage medium for practicing the method of allowing students to practice a component of an exercise before completing a graded component. At least one parameter is associated with an exercise, which includes a practice component and a graded component. A request is received for the exercise. A determination is made whether the student must work on the practice component before working on the graded component. If so, the student must pass the practice component before being allowed to attempt the graded component. The exercise is then presented to the student and is conducted according to the parameter(s) set for the exercise. Attempts to work on the graded component may be earned upon successful completion of the practice component.

### CROSS-REFERENCE TO RELATED APPLICATION

This application claims priority from U.S. provisional application No. 60/620,087, filed Oct. 18, 2004.

### TECHNICAL FIELD

This invention relates to online homework systems.

### BACKGROUND

Online homework systems may be employed to present exercises to students either in the classroom or outside of the classroom. Some of these systems allow a teacher to designate certain assignments as prerequisites for others, thereby making students follow a certain path as they do their work. Theoretically, a teacher could force students to practice by inserting extra prerequisite assignments in between graded components. However, having to create a new assignment simply to force students to practice results in more work for teachers. In addition, not all students need the same amount of practice on different concepts. Finally, merely having prerequisite assignments does not demonstrate to the students the value of practice and preparation in advance of a test or quiz.

It would be advantageous to provide a method and system for providing students with online assignments and/or tests which forces students to practice (and if desired, master) a concept before taking a graded component of the assignment. It would be further desirable to provide an incentive to students to practice problems relating to different concepts. It would also be advantageous to provide a method and system that allowed a teacher to create only one assignment, for which graded and practice components could be turned on or off easily by changing a minimum number of parameters.

### SUMMARY

A method allowing students to practice an assignment before completing a graded component comprises receiving a request for an exercise including the graded component and a practice component. The exercise has at least one parameter associated with it. A determination is made as to whether a student must work on the practice component, wherein the student must pass the practice component before being allowed to attempt the graded component. The exercise is presented to the student, wherein the exercise is conducted according to the at least one parameter. This method may be performed by software.

### BRIEF DESCRIPTION OF THE DRAWINGS

FIG. 1 is a block diagram of a network configuration in an exemplary embodiment of the invention.

FIG. 2 is a flow chart showing the creation of an exercise in an exemplary embodiment of the invention.

FIG. 3 is a menu of exercises which may be presented to the student in one embodiment of the invention.

FIG. 4 is a menu of options which may be presented to the student in one embodiment of the invention.

FIG. 5 is a flow chart showing the presentation of an exercise in an exemplary embodiment of the invention.

FIG. 6 is a result of a practice component which may be presented to a student in one embodiment of the invention.

FIG. 7 is a flow chart showing the presentation of an exercise in an exemplary embodiment of the invention.

### DETAILED DESCRIPTION

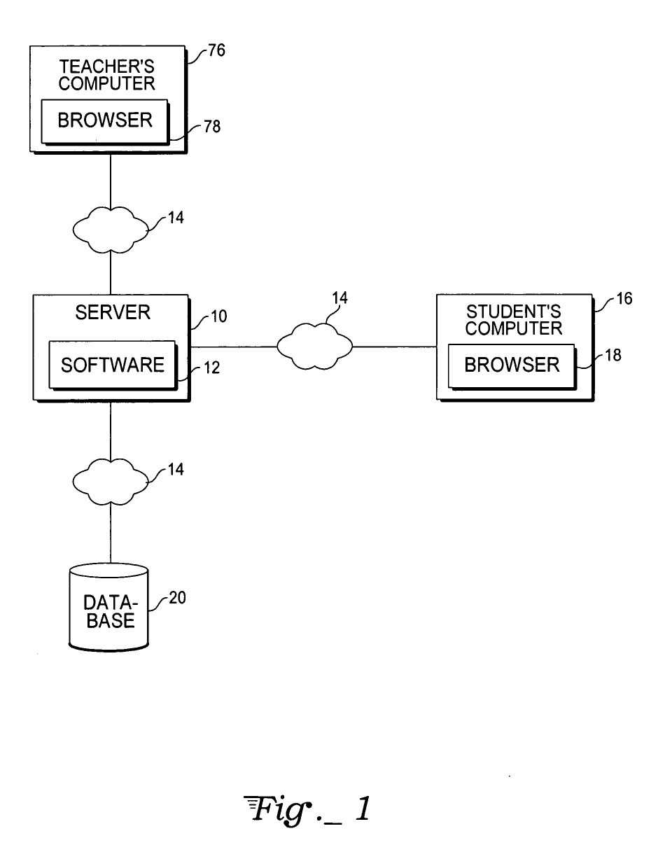

In FIG. 1, one embodiment features a server 10 running software 12 for presenting and controlling homework assignments/tests. (This “homework software” 12 is in addition to other software running on the server which controls the server's operations and network activities.) (As is well-known in the art, software is a computer-readable storage medium (including compact disc, computer diskette, computer memory, etc.) with code, or instructions, which, when read and executed by the computer, causes the computer to perform a process or task.) A database 20 is also connected to the server 12 via a network connection 14. The server 10 is connected, via a network 14, such as the Internet, to the student's computer 16. The student's computer 16 in this embodiment has an Internet browser 18, such as NETSCAPE NAVIGATOR or INTERNET EXPLORER, in addition to any other software, such as an operating system and network software, required for the computer's operation. The browser 18 requests a website hosted by the server running the homework software 12. The student is thus able to access the homework software 12 via a Web interface. A teacher's computer 76 is also connected to the server via a network 14, such as the Internet. The teacher's computer 76 in this embodiment has an Internet browser 18, such as NETSCAPE NAVIGATOR or INTERNET EXPLORER, in addition to any other software, such as an operating system and network software, required for the computer's operation. The browser 18 requests a website hosted by the server running the homework software 12. The teacher is thus able to access the homework software 12 via a Web interface. The teacher and students send HTTP requests to the server 10 (in this embodiment, the server 10 is an HTTP server) which processes those requests and communicates with the database 20 via program scripts. In other embodiments, the student's and/or teacher's computers may be running resident versions of the homework software rather than using a Web interface; in these embodiments, the software on the student's/teacher's computers would report scores to a central or local database and/or receive updates and instructions from the server 10 via a network connection. In yet other embodiments, the database 20 may be running on the server 10, may be directly connected to the server 10, or may be local to the teacher's or student's computers. The homework software is not platform specific. For the purpose of explanation, only one teacher's computer and one student's computer have been shown here; however, it is contemplated that any number of teachers' and students' computers could be present in a system.

The homework/test-taking system can be set up to require the student to practice an assignment before working on a graded component, such as a graded homework assignment or a test. Depending on parameters (discussed in greater detail below) chosen by the teacher when creating the exercise, the student may have a number of “free” attempts at trying the graded component at any time and/or may have to earn an attempt at working on the graded component by passing a practice component.

In one embodiment, the homework system should be able to generate different random versions of the same problem. In other words, the same type of problem, but with different numbers or parameters, should be generated. For instance, for a mathematics exercise, one student may see the problem 10x+5=20x while another student may see the problem 2y+1=6y. Implementation of this feature is well-known to those of skill in the art.

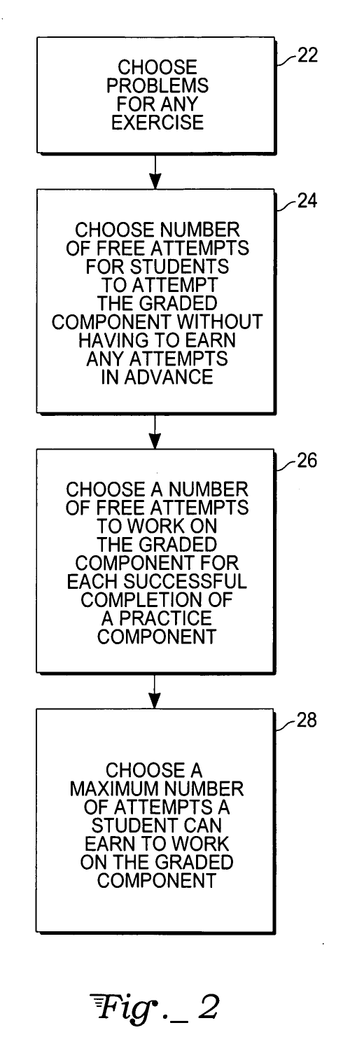

With respect to the exemplary embodiment illustrated in FIG. 2, when creating an exercise, a teacher chooses problems for an exercise (block 22). The teacher also chooses a number of free attempts (“n”) for the student to attempt the graded component without having to earn any attempts in advance (block 24). The teacher also chooses a number of free attempts (“v”) to work on the graded components which are given to the student upon successful completion of a practice component (block 26). The teacher also chooses a maximum number of attempts (“m”) a student can earn to work on the graded component (block 28). (In one embodiment, the sum of the number of free attempts (“n”) and the maximum number of attempts that may be earned (“m”) represents the maximum number of times a student may try the graded component of an exercise.) For instance, the teacher can set parameters where the student is given one free try, the maximum number of earned tries is six, and each successful practice earns one attempt or “try” of the graded component. The parameters chosen by the teacher are stored in the database.

In other embodiments, the teacher can choose at least one of a number of different parameters to be associated with an exercise. These parameters may include: a number of free attempts to work the graded component (“n”); a number of free attempts to work on the graded component which are earned for each successful practice component (i.e., when the practice component is passed) (“v”); a maximum number of attempts to work on the graded component which may be earned (“m”); a time limit for one attempt of the practice component; a minimum score required to pass the practice component; a maximum number of times student may guess an answer of a particular problem on the practice component; whether a teacher, or some other supervisor, must be present while the student takes the graded component; any feedback to be provided for at least one of the practice component or the graded component; any reduction in grade based on a number of attempts of the graded component before passing the graded component; and the maximum number of times a student may try the graded component of an exercise.

When setting parameters for an exercise, the teacher may choose not to employ a system where attempts or tries of the graded component may be earned. If this is the case, the number of free tries of the graded component is set to 1, the number of tries earned for each successful practice is set to 0, and the maximum number of earned tries is also set to 0.

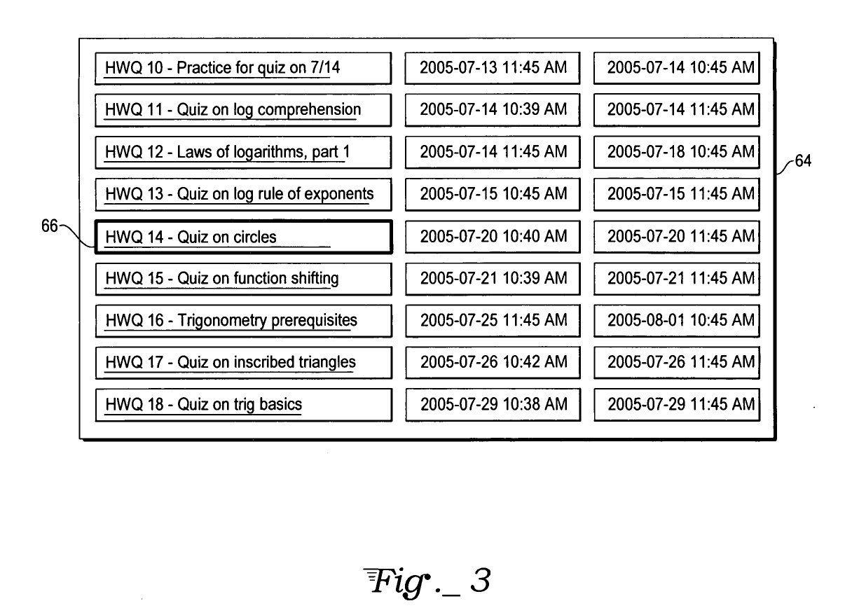

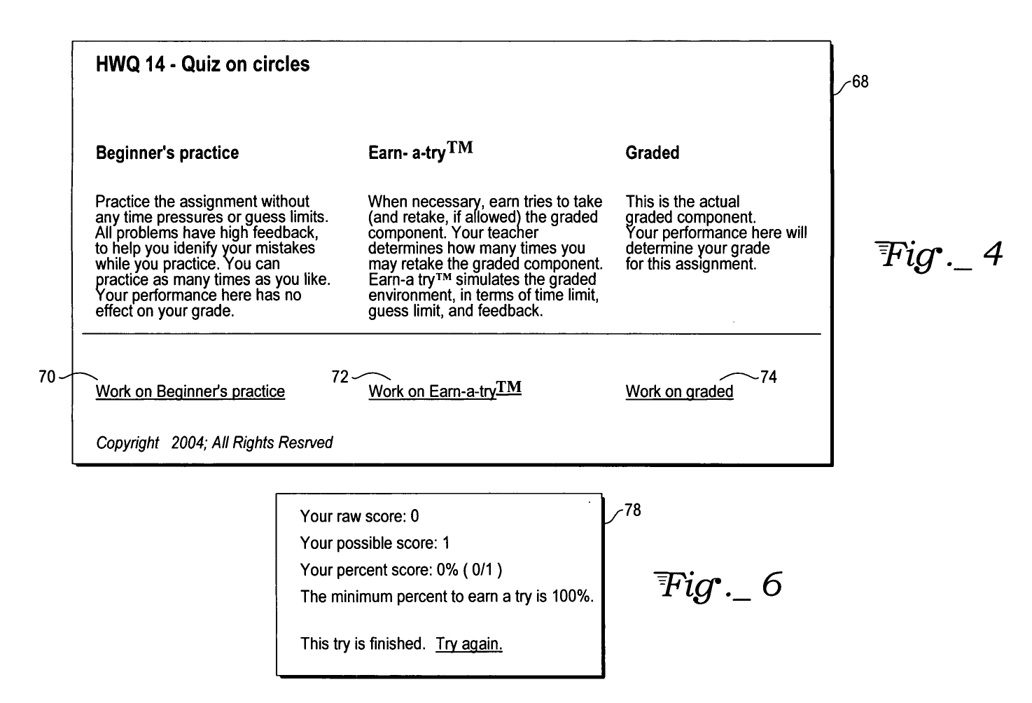

With respect to FIG. 3, in one embodiment the student selects an exercise 66 on which to work. This selection may be made, for instance, from a menu 64 listing the different exercises available to the student. The assignments for which attempts or tries to work on the graded component may be highlighted for the student. In FIG. 4, in one embodiment, the student is presented with various choices 68 after selecting the highlighted exercise 66 in FIG. 3. For instance, the student could choose “Beginner's Practice” 70, where the student can work on problems similar to those in the graded component without any time pressure or limits on guesses; the student's performance here would not be graded. Feedback could also be provided here. The student could also select “Earn-a-try”™ 72, where attempts, or tries, to work on the graded component may be earned. This approach would simulate the environment of the graded component. Finally, if the student is allowed to proceed directly to the graded component 74 (as discussed in greater detail below), the student may choose to work on the graded component.

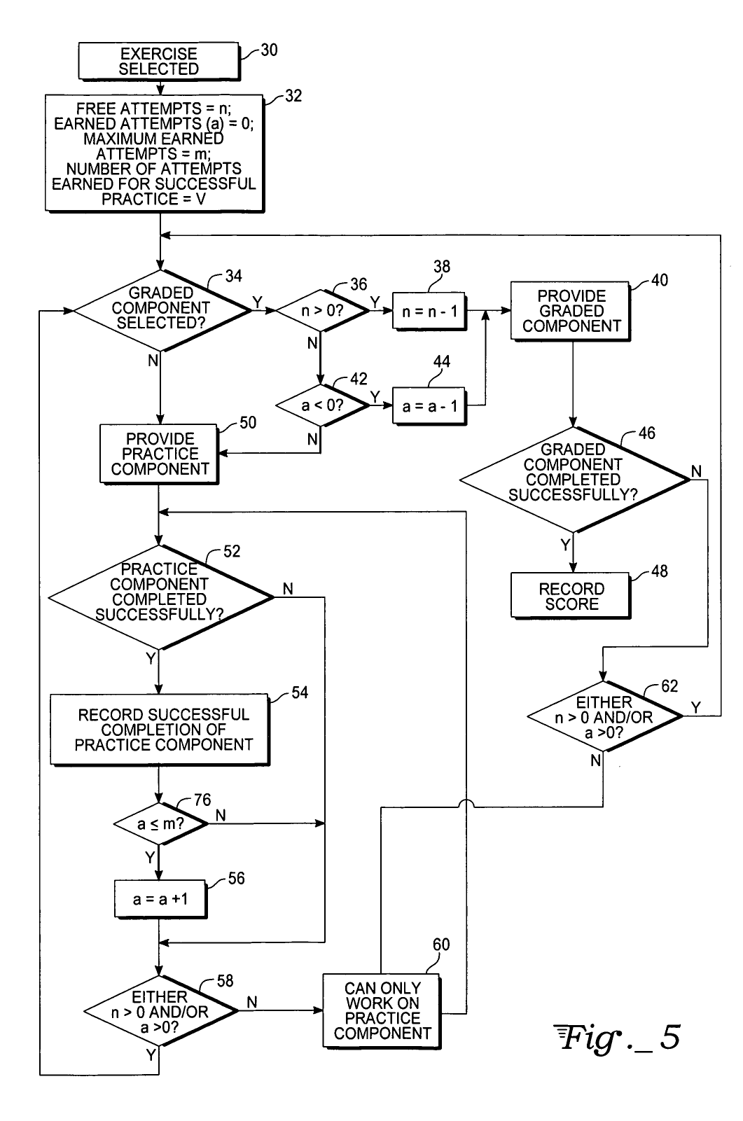

In FIG. 5, the student selects an exercise (block 30). With reference to the Web interface configuration discussed above in FIG. 1, the student's choice is then relayed to the server, which sends the appropriate information for the student and the selected exercise to the student's browser. In this embodiment, the student may choose between a practice component, where attempts or tries to work on the graded component may be earned, or the graded component. Referring to the parameters chosen above in FIG. 2, the number of free attempts n and the maximum number of earned attempts m are retrieved from the database; the number of earned attempts (also retrieved from the database) “a” is set to zero (block 32). (In other embodiments, the student previously may have earned attempts on this exercise, which are stored in the database and are available to the student whenever the student resumes work on an exercise.) For exemplary purposes, n=1 and m=6 and each successful practice earns one attempt or “try” of the graded component.

If the student chooses first to work on the graded component (block 34), the student must have at least one free attempt to work on the graded component. A determination is made as to whether n>0 (block 36). In this case, the student has 1 free attempt, so n is greater than 0. The student's number of free attempts n is reduced by one (block 38) and the student is provided with the graded component (block 40). The student works on the graded component, which is graded when it is completed (block 46). If the graded component is completed successfully (block 46), the score is recorded (block 48) in the database. The teacher may set a minimum passing grade for the assignment or the system may have a default passing grade (such as 70%). The score for the graded component may be immediately reported to the student in one embodiment.

If the student does not choose to work on the graded component (block 34), the student is provided with a practice component (block 50). If the practice component is completed successfully (block 52) (this may be determined by a parameter entered by the teacher or a default setting, such as scoring 70% or more), the successful completion of the practice component is recorded in the database (block 54). Referring to FIG. 6, the student may be presented with the results 78 of the practice component, which may also indicate the minimum score (here 100%) required to earn a try.

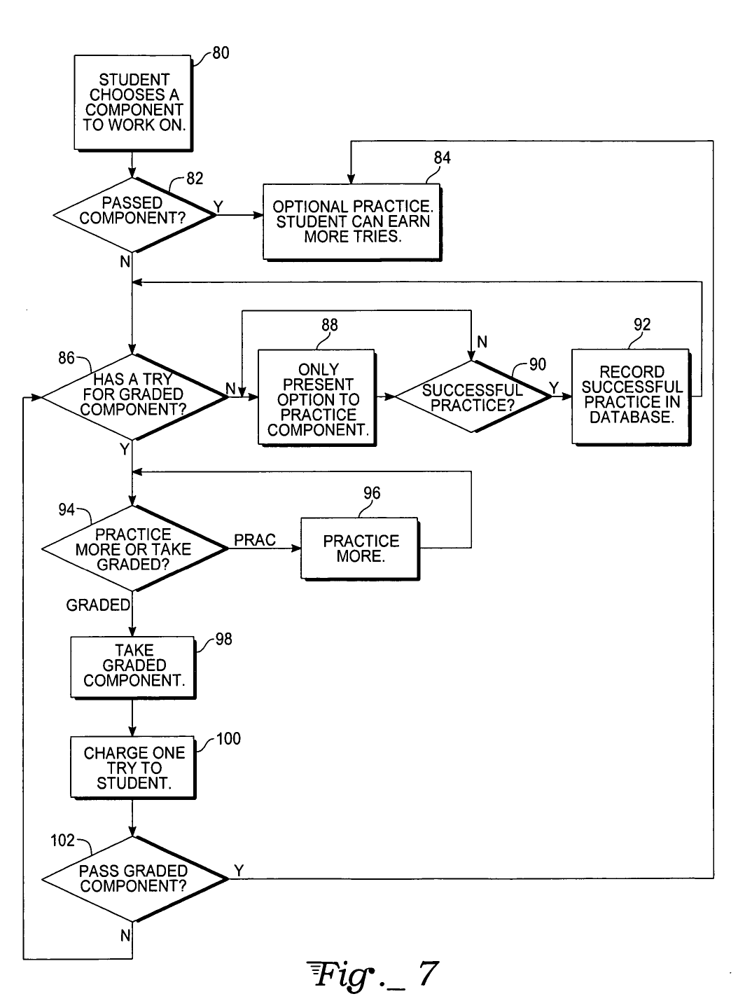

Returning to FIG. 5, if the number of earned attempts does not exceed the maximum allowable number of earned attempts (block 76), the number of earned attempts is incremented by 1 (block 56) and stored. (This assumes v, or the number of attempts earned for each successful practice, =1. Other embodiments, where another number of attempts may be earned, are discussed in FIG. 7, below.) If the student has already earned the maximum allowable number of earned attempts (block 76), a determination is made of whether the student has a number of free attempts and/or a number of earned attempts (block 58).

If the student has more free attempts and/or the number of earned attempts does not exceed the maximum number of earned attempts allowed by the parameters entered by the teacher (block 58), the student has a choice of working on another practice component or working on the graded component (block 34). If the student chooses to work on the graded component (block 34), a determination is made as to whether the student has any free attempts left (block 36). In this example, n now equals 0. A determination is then made as to whether the student has any earned attempts (block 42). In this example, the student has one earned attempt (block 42). The number of earned attempts is reduced by one (block 44), and the student is provided with the graded component (block 40).

If the student had no free attempts (block 36) or earned attempts (block 42), the student would be provided with the practice component (block 50).

If at any time the student does not successfully complete the practice component (block 52), and the student has no more free attempts to try the graded component or no earned attempts to try the graded component (block 58), the student may only work on the practice component (block 60).

If the student does not successfully complete the graded component (block 46), but the student has more free attempts and/or earned attempts to try the graded component (block 62), the student may choose to try either the practice component or the graded component (block 34). However, if the student does not have more free attempts and/or earned attempts to try the graded component (block 62), the student may only work on the practice component (block 60).

In other embodiments, if the student does not have either earned attempts or free attempts to try the graded component, the option to take the graded component will not be presented to the student and the student will only be allowed to work on practice components.

If the student fails either a practice component or the graded component, and the student attempts either component again, the student will see the same problems. In other embodiments, new problems may be generated.

In other embodiments, as noted above, various parameters which are associated with the exercise may be set. In FIG. 7, the student chooses to work on a component (either a practice component or a graded component) (block 80). If the student passes the component (block 82), the student may optionally practice the component more (and, if the component was a practice component, may earn tries of the graded component) (block 84). If the student did not pass the component (block 82), the student may still try the graded component if he or she has attempts or tries of the graded component (block 86). The parameters set by the teacher control whether the student may try the graded component.

In one embodiment, whether the student may take the graded component is a function of the number of both free and earned tries available to him or her at any time, as well as the number of tries already used. One way to determine the number of available tries A is given by the equation: A=F+E−U, where F is the number of free tries, U is the number of times the student has attempted the graded component, and E is the minimum of M and int (S*T), where M is the maximum number of earned tries, S is the number of successful practices, T is the number of tries earned for each successful practice, and int(x) returns the integer value of a real number x.

As a simple example, consider the following parameters for an exercise: F=2; M=6, and T=1 (i.e., 2 free tries, 6 maximum earned tries, and 1 try earned for each successful practice). Consider a student who has the following situation for that exercise: S=3, U=4 (i.e., 3 successful practices and 4 attempts of the graded component). Thus, F=2, M=6, T=1, U=4, and S=3, so E=minimum (6, int(1*3))=3. Therefore, the number of available tries this student has for the graded component is 2+3−4=1.

If a student has an available try, then the software allows the student to take the graded component. If a student does not have an available try, then the software forces the student to earn a try to work on the graded component. If the student does not have an available try, but cannot earn any more tries, then the software only allows the student to practice the exercise, although successful practices will not earn him or her any additional tries.

One embodiment features a relational database with the following exemplary tables and fields. The database is assumed to have tables that represent students and problems, entities which are standard with most online instruction systems. Each table is assumed to have a unique ID field.

TABLE

| | | Correlation with |
|---|---|---|
| | Necessary fields | Parameters |
| Exercise | free_tries | F |
| | earned_per_success | T |
| | max_earn_tries | M |
| | pract_time_limit | |
| | pract_min_score | |
| Join_student_exercise | student | |
| | exercise | |
| | used | U |
| | practice_successes | S |
| | practice_seed | |
| | graded_seed | |
| Join_problem_exercise | problem | |
| | exercise | |
| | max_prac_guesses | |

Each student and exercise is represented by a single record in the student and exercise tables, respectively. The student table is not shown because no additional fields are needed in that table beyond those in a standard online instruction system. For each student and exercise, one record is created in the join_student_exercise table described above. For each problem of each exercise, one record is created in the join_problem_exercise table.

The fields in the tables are described below:

exercise table

free_tries

Description: The number of free tries granted to each student.

Values: Nonnegative integers or ‘inf’ for unlimited.

earned_per_success

Description: The number of tries earned by each successful practice.

Values: Nonnegative real numbers or ‘inf’ for unlimited.

max_earn_tries

Description: The maximum number of tries each student may earn.

Values: Nonnegative integers or ‘inf’ for unlimited.

pract_time_limit

Description: The time allowed for a student to complete a practice component.

Values: Valid time entries of the form DD:HH:MM:SS (days, hours, minutes, seconds), or ‘inf’ for unlimited.

pract_min_score

Description: The minimum score required for a practice component to be considered successful.

Values: Percents between 0 and 100.

join_student_exercise table

student

Description: The unique ID representing a particular student.

exercise

Description: The unique ID representing a particular exercise.

used

Description: The number of times a student has attempted the graded component.

Values: Nonnegative integers.

practice_successes

Description: The number of successful practices.

Values: Nonnegative integers.

practice_seed

Description: Used to seed the random number generator on the server, so that different numbers and parameters are used each time the student tries another practice component of the exercise.

Values: Integers.

graded_seed

Description: Used to seed the random number generator on the server, so that different numbers and parameters are used each time the student tries another graded version of the exercise.

Values: Integers.

join_problem_exercise table

problem

Description: The unique ID representing a particular problem.

exercise

Description: The unique ID representing a particular exercise.

max_prac_guesses

Description: The maximum number of times a student may submit a guess on a particular problem of a practice component.

Values: Nonnegative integers.

In one embodiment, if A>0, then a student may attempt a new version of the graded component. Otherwise, such an option is not presented. If a student chooses to try a new attempt of the graded component (whether or not this is his first attempt), then:

The value join_student_exercise.graded_seed is replaced with a new random number, thereby generating new problems for the student.

The value of join_student_exercise.used in the database is increased by one.

In other embodiments, different tables and fields may be employed.

In another embodiment, a student is always presented the option to practice the exercise again. If a student chooses to try a new attempt of the practice component (whether or not this is his first attempt), then:

The value join_student_exercise.practice_seed is replaced with a new random number, thereby generating new problems for the student.

Each time a student successfully completes a practice component, then:

The value of join_student_exercise.practice_successes in the database is increased by one.

Returning to FIG. 7, if the student has a try, either free or earned, for the real exercise (block 86) (which may be determined using the equation A=F+E−U, discussed above), the student may be presented with the option to either take the graded component or the practice component (block 94). However, if the student is not eligible to try the graded component (block 86), the student is only presented the option to practice the exercise (block 88). If the practice is successful (block 90), the successful attempt is recorded in the database and, where applicable, a try of the graded component may be earned and recorded (block 92). However, if the practice is not successful (block 90), the student is again only presented with the option to take the practice component (block 88).

If the student elects to take the graded component (blocks 94 and 98), a “try” is then charged to the student as discussed above (block 100). If the graded component is passed, the result is recorded in a database (block 102). The student may then optionally practice the exercise further, and potentially earn more tries of the graded component (for instance, to improve his or her grade) (block 84). However, if the graded component is not passed (block 102), the student may take the graded component again only if the student is eligible to do so, e.g. has another try of the graded component (block 86). Even if the student is eligible to take the graded component, the student has the option to practice the exercise further (blocks 94 and 96).

In one embodiment, each time a student chooses to do a new practice or graded component, new problems must be selected. As mentioned earlier, a requirement of the online system is that it be able to generate different versions of the same problem by using different numbers or parameters. Thus, each time the student requests to try again either practice or graded component, new versions of each problem are generated for that student.

Depending on how the exercise is set up, the earned attempts may only be used for specific exercises (for instance, the exercise for which they were earned) or may be used any time, regardless of the exercise.

The homework/testing system described above offers an automatic mechanism to force students to practice a computer-based exercise prior to attempting the graded component. The system may be employed for various purposes, including, but not limited to, a quiz environment or practicing skill problems. The system may be used for exercises on any subject matter.

The teacher only has to spend a short period of time creating the “earn-a-try” component of the exercise. In fact, if the system stores his or her preferred parameter choices during the exercise creation phase, the “earn-a-try” component could automatically appear as each new assignment is introduced to students.

The teacher may also force students to practice an exercise by setting the free tries to zero. When this occurs, there is no way to take the graded component of the exercise without successfully passing the “earn-a-try.”

Each successful practice is like a token that allows students to retake the graded component of the exercise. If the teacher allows students to re-do an exercise, then students quickly learn the value of earning these tokens.

While the preceding description has described specific embodiments, it will be evident to a skilled artisan that various changes and modifications can be made to these embodiments. The specification and drawings, therefore, are to be regarded in an illustrative rather than a restrictive sense.

What is claimed is:

1. A method allowing students to practice a component of an exercise before completing a graded component, the method comprising:
a) receiving a request for an exercise including the graded component and a practice component, the exercise having at least one parameter associated with the exercise;
b) determining whether a student must work on the practice component, wherein the student must pass the practice component before being allowed to attempt the graded component; and
c) presenting the exercise to the student, wherein the exercise is conducted according to the at least one parameter.

2. The method of claim 1 wherein the at least one parameter includes at least one of the following:
a) a first number of free attempts to try the graded component;
b) a second number of free attempts to try the graded component earned each time the practice component is passed;
c) a maximum number of attempts to try the graded component which may be earned;
d) a time limit for one attempt at the practice component;
e) a minimum score required to pass the practice component;
f) a maximum number of times a student may guess an answer of a particular problem in the practice component;
g) whether a teacher must be present while the student takes the graded component;
h) any feedback to be provided for at least one of the practice component and the graded component;
i) problem variation in at least one of the practice component and the graded component;
j) any reduction in a grade based on a number of attempts of the graded component; or
k) a maximum number of times the student may attempt the graded component.

3. The method of claim 1 further comprising grading the practice component or the graded component taken by the student.

4. The method of claim 3 further comprising storing the student's results for at least one of the practice component or the graded component.

5. The method of claim 1 further comprising tracking at least one of a number of times the student attempts the practice component or a number of times the student attempts the graded component.

6. The method of claim 1 further comprising giving a student a predetermined number of attempts to try the graded component upon successful completion of the practice component.

7. The method of claim 5 further comprising only allowing the student to take the practice component where the student has no free attempts to try the graded component and no attempts to try the graded component which are earned.

8. The method of claim 1 further comprising giving the student an attempt to try the graded component upon successful completion of the practice component.

9. The method of claim 1 further comprising storing a number of attempts earned by the student.

10. A computer-readable storage medium storing instructions that, when executed by a computer, cause the computer to perform a method allowing students to practice a component of an exercise before completing a graded component, the method comprising:
a) receiving a request for an exercise including the graded component and a practice component, the exercise having at least one parameter associated with the exercise;
b) determining whether a student must work on the practice component, wherein the student must pass the practice component before being allowed to attempt the graded component; and
c) presenting the exercise to the student, wherein the exercise is conducted according to the at least one parameter.

11. The computer-readable storage medium of claim 10 wherein the at least one parameter includes at least one of the following:
a) a first number of free attempts to try the graded component;
b) a second number of free attempts to try the graded component earned each time the practice component is passed;
c) a maximum number of attempts to try the graded component which may be earned;
d) a time limit for one attempt at the practice component;
e) a minimum score required to pass the practice component;
f) a maximum number of times a student may guess an answer of a particular problem in the practice component;
g) whether a teacher must be present while the student takes the graded component;
h) any feedback to be provided for at least one of the practice component and the graded component;
i) problem variation in at least one of the practice component and the graded component;
j) any reduction in a grade based on a number of attempts of the graded component; or
k) a maximum number of times the student may attempt the graded component.

12. The computer-readable storage medium of claim 10, the method further comprising grading the practice component or the graded component taken by the student.

13. The computer-readable storage medium of claim 12, the method further comprising storing the student's results for at least one of the practice component or the graded component.

14. The computer-readable storage medium of claim 10, the method further comprising tracking at least one of a number of times the student attempts the practice component or a number of times the student attempts the graded component.

15. The computer-readable storage medium of claim 10, the method further comprising giving a student a predetermined number of attempts to try the graded component upon successful completion of the practice component.

16. The computer-readable storage medium of claim 14, the method further comprising only allowing the student to take the practice component where the student has no free attempts to try the graded component and no attempts to try the graded component which are earned.

17. The computer-readable storage medium of claim 10, the method further comprising giving the student an attempt to try the graded component upon successful completion of the practice component.

18. The computer-readable storage medium of claim 10, the method further comprising storing a number of attempts earned by the student.
